(19) United States
(12) Patent Application Publication
(10) Pub. No.: US 2014/0176626 A1
(43) Pub. Date: Jun. 26, 2014

(54) DISPLAY DEVICE AND DRIVE METHOD FOR SAME

(71) Applicant: Takashi Sasaki, Osaka-shi (JP)

(72) Inventor: Takashi Sasaki, Osaka-shi (JP)

(73) Assignee: Sharp Kabushiki Kaisha, Osaka-shi, Osaka (JP)

(21) Appl. No.: 14/236,483

(22) PCT Filed: Aug. 29, 2012
(86) PCT No.: PCT/JP2012/071912

§ 371 Date: Jan. 31, 2014

(30) Foreign Application Priority Data
Aug. 31, 2011 (JP) 2011-189648

(51) Int. Cl. G09G 3/36

(52) U.S. Cl. CPC G09G 3/3607
USPC 345/697; 345/690; 345/89

(57) ABSTRACT

A liquid crystal display device includes a display screen which displays an input image based on input image data. In a case where the display screen displays an image having a uniform grayscale, the display screen displays a check-patterned image on a part that includes a luminance boundary. This makes it possible to provide (i) a displays device capable of certainly reducing display unevenness so as to increase display quality and (ii) a method of driving the display device.

### TECHNICAL FIELD

The present invention relates to (i) a display device such as a liquid crystal display device and (ii) a method of driving the display device.

### BACKGROUND ART

Conventionally, display devices have a problem of display unevenness that occurs on a display screen as a result of a manufacturing error.

For example, a large display panel separately includes right and left color filters for a structural reason. If there is an error in manufacturing the color filters, then it causes a recognizable boundary (highlighting a luminance difference) at a part of a display screen of the display panel, at which part the right and left color filters are joined together.

(a) of FIG. 28 is a view illustrating a state in which an image is displayed on a display screen of a display panel in a case where there is a luminance difference. The display panel is provided with a left color filter and a right color filter on a left-half region of the display panel and on a right-half region of the display panel, respectively. In a case where there is a luminance difference between the right and left color filters due to a manufacturing issue, a viewer recognizes a boundary (highlighting a luminance difference) at a part of the display screen, at which part the right and left color filters are joined together (see (a) of FIG. 28).

Conventionally, proposals have been made for a display device that carries out grayscale correction, as a technology for reducing display unevenness (luminance difference). Specifically, in a case where there is a luminance difference between right and left sides of a display screen, the display device carries out grayscale corrections such that a luminance of one side of the screen is adjusted to match that of the other side of the screen. For example, in a case where a luminance of a left-half region of a display screen is lower (darker) than that of a right-half region of the screen as illustrated in (a) of FIG. 28, a grayscale value of a data signal (input image) corresponding to the left-half region is increased so that the luminance of the left-half region becomes higher (brighter). This causes the respective luminances of the right-half and left-half regions to be uniform, and therefore allows for a reduction in display unevenness (see (b) of FIG. 28).

According to a display device of Patent Literature 1, display unevenness is reduced by (i) specifying a size and a position of a quadrilateral region on a display screen and (ii) correcting a grayscale of an area to which the quadrilateral region corresponds as well as gradually reducing, in horizontal and vertical directions, grayscale variances in the vicinity of the area.

### CITATION LIST

### Patent Literature

Patent Literature 1
Japanese Patent Application Publication, Tokukai, No. 2005-134560 A (Publication Date: May 26, 2005)

### SUMMARY OF INVENTION

### Technical Problem

With the conventional technology, however, there are limitations on precision in grayscale adjustment since it is grayscales that are corrected. Specifically, grayscale adjustment is carried out in grayscale units. For example, in a case where a luminance difference between right and left sides of a display screen is smaller than one gray scale, it is impossible to match the respective luminances of the right and left sides even if grayscales are corrected. In a case where, in particular, a luminance difference between right and left sides of a display screen is smaller than 0.5 grayscale, grayscale correction causes the luminance difference to be large. This causes display quality to be even lower than that before the grayscale correction. (a) of FIG. 29 schematically illustrates a state in which a luminance difference between a right-half region and a left-half region of a display screen is smaller than 0.5 grayscale. In (a) of FIG. 29, the left-half region is slightly darker than the right-half region. In this case, conventional grayscale correction, i.e., correction to increase only the left-half region by one grayscale (without correcting the right-half region), causes a reversal of a light-dark contrast between the right and left regions. That is, the left-half region becomes brighter than the right-half region as illustrated in (b) of FIG. 29. Even worse, a luminance difference between the right-half region and the left-half region on the display screen after the grayscale correction (as illustrated in (b) of FIG. 29) is greater than that before the grayscale correction (as illustrated in (a) of FIG. 29). This causes display quality to be lower than that before the grayscale correction.

In recent years, in particular, a luminance difference derived from a manufacturing error has been made small, due to the advancement of a technology for manufacturing large display panels. This makes it difficult to reduce display unevenness with the conventional technology.

The present invention has been made in view of the problem, and it is an object of the present invention to provide a display device and a method of driving the display device, which allow an increase in display quality.

### Solution to Problem

A display device in accordance with the present invention includes: a display screen on which an input image is displayed, the input image being based on input image data which has been inputted into the display device, in a case where an image having a uniform grayscale is to be displayed on at least part of the display screen, the display screen displaying, on at least a predetermined region of the part, a patterned image which has been set in accordance with the input image in advance.

With the configuration, it is possible to display, on a part including a luminance boundary, a preset patterned image in a case where, for example, the luminance boundary (display unevenness) is recognizable when an image having a uniform grayscale (what is known as a solid image) is to be displayed on the display screen. Note that the patterned image can be, for example, a check-patterned image having two differing grayscales each corresponding to a display luminance. By displaying such a patterned image on the part including the luminance boundary, the luminance boundary can be made unnoticeable.

Such grayscale correction for reducing display unevenness is different from the conventional grayscale correction in that such grayscale correction is effective even in a case where a luminance difference is minimal (e.g. equal to or less than 1 grayscale). This makes it possible to certainly reduce display unevenness, and therefore allows for an increase in display quality.

A method of the present invention is a method of driving a display device, said display device including: a display screen on which an input image is displayed, the input image being based on input image data which has been inputted into the display device, said method including the steps of: (i) receiving an input image from an external source; (ii) determining, by recognizing the input image, whether or not the input image needs to be corrected; (iii) in a case where it was determined in the step (ii) that the input image needs to be corrected, obtaining a patterned image which corresponds to the input image thus recognized in the step (ii) and which is stored in a storage section in advance; and (iv) generating a corrected image in accordance with the patterned image thus obtained in the step (iii) and with the input image thus received in the step (i), in a case where it was determined in the step (ii) that the input image needs to be corrected, an image based on the corrected image being displayed.

### Advantageous Effects of Invention

According to a display device and a method of driving the display device in accordance with the present invention, the following is thus realized: In a case where an image having a uniform grayscale is to be displayed on at least part of a display screen, a patterned image, which has been set in accordance with an input image in advance, is displayed on a predetermined region of the part. This makes it possible to provide (i) a displays device capable of certainly reducing display unevenness so as to increase display quality and (ii) a method of driving the display device.

### BRIEF DESCRIPTION OF DRAWINGS

FIG. 1 is a block diagram illustrating a configuration of a display control circuit in a liquid crystal display device in accordance with the present embodiment.

FIG. 2 is a flow chart illustrating an operation of the display control circuit illustrated in FIG. 1.

FIG. 3 is a block diagram schematically illustrating a configuration of the liquid crystal display device in accordance with the present embodiment.

FIG. 4 is a view illustrating how a display screen displays a corrected image in accordance with Example 1.

FIG. 5 is a view illustrating an image corresponding to A grayscale of an input image which has been inputted from an external signal source.

FIG. 6 is a view illustrating how a display screen displays an image without carrying out grayscale correction in accordance with the present embodiment.

FIG. 7 is a set of views (a) and (b), (a) of FIG. 7 illustrating an image in a case where a luminance difference between right and left regions of the display screen in FIG. 6 is small and (b) of FIG. 7 schematically illustrating how the display screen displays a corrected image that corresponds to the image illustrated in (a) of FIG. 7.

FIG. 8 is a set of views (a) and (b), (a) of FIG. 8 illustrating an image to be displayed, the image being configured so that there is a difference in luminance (grayscale) between (i) a central region of a display screen and (ii) an outer region of the display screen by which the central region is surrounded and (b) of FIG. 8 illustrating a luminance boundary that appears on the image illustrated in (a) of FIG. 8.

FIG. 9 is a view illustrating how the display screen displays the image illustrated in FIG. 8 in a case where a patterned image is displayed in addition.

FIG. 10 is a set of views (a) and (b), (a) of FIG. 10 illustrating an image to be displayed, the image being configured so that (I) there is a difference in luminance (grayscale) between (i) a central region of a display screen and (ii) an outer region of the display screen by which the central region is surrounded and (II) an overall grayscale of the image is low and (b) of FIG. 10 illustrating a luminance boundary that appears on the image illustrated in (a) of FIG. 10.

FIG. 11 is a view illustrating how the display screen displays the image illustrated in FIG. 10 in a case where a patterned image is displayed in addition.

FIG. 12 is a view illustrating how a display screen displays a corrected image in accordance with Example 2.

FIG. 13 is a set of views (a) through (d) illustrating patterned images each corresponding to respective grayscales.

FIG. 14 is a view illustrating how a display screen displays a corrected image in accordance with Example 3.

FIG. 15 is a set of views (a) and (b) illustrating how a display screen displays an image in a case where an input image (solid image) has a grayscale, (a) of FIG. 15 illustrating the image without grayscale correction and (b) of FIG. 15 illustrating the image which has been subjected to the grayscale correction.

FIG. 16 is a view illustrating how a display screen displays a corrected image in accordance with Example 4.

FIG. 17 is a set of views (a) and (b) illustrating how a display screen displays an image in a case where an input image (solid image) has a grayscale, (a) of FIG. 17 illustrating the image without grayscale correction such that a right-half region of the display screen is presented with a luminance corresponding to a grayscale whereas a left-half region of the display screen is presented with a luminance corresponding to b grayscale and (b) of FIG. 17 illustrating the image which has been subjected to the grayscale correction such that (I) a center part including a luminance boundary displays a check-patterned image, (II) a ratio of pixels a, each of which has a luminance corresponding to a grayscale, to pixels b, each of which has a luminance corresponding to b grayscale, is low in the left-half region, and (III) a ratio of the pixels b to the pixels a is low in the right-half region.

FIG. 18 is a view illustrating how a display screen displays a corrected image in accordance with Example 5.

FIG. 19 is a set of views (a) and (b) illustrating how a display screen displays an image in a case where an input image (solid image) has a grayscale, (a) of FIG. 19 illustrating the image without grayscale correction such that a right-half region of the display screen is presented with a luminance corresponding to a grayscale whereas a left-half region of the display screen is presented with a luminance corresponding to b grayscale and (b) of FIG. 19 illustrating the image in a case where a center part, which includes a luminance boundary, displays a patterned image including c grayscale.

FIG. 20 is a view illustrating an image configured differently from the image illustrating in FIG. 18.

FIG. 21 is a set of views (a) and (b) each illustrating an image configured differently from the image illustrated in FIG. 18.

FIG. 22 is a block diagram illustrating a configuration of a liquid crystal display device in accordance with another configuration example of the present embodiment.

FIG. 23 is an equivalent circuit diagram illustrating part of a liquid crystal panel in the liquid crystal display device illustrating in FIG. 22.

FIG. 24 is a set of views (a) and (b), (a) of FIG. 24 illustrating respective input timings of frames A through D and (b) of FIG. 24 illustrating timings of writing operation timings according to the liquid crystal display device illustrated in FIG. 22.

FIG. 25 is a view illustrating how a common liquid crystal display device, which employs a 1V inversion drive system, displays a solid white image.

FIG. 26 is a view illustrating how a liquid crystal display device displays a solid white image in a case where a 1V inversion drive system is applied to a screen division drive system.

FIG. 27 is a view illustrating how a display screen displays an image in a case where the image illustrated in FIG. 26 has been subjected to the grayscale correction in accordance with Example 2.

FIG. 28 is a set of views (a) and (b) for describing a conventional technology, (a) of FIG. 28 illustrating how a luminance difference exists on a display screen of a display panel and (b) of FIG. 28 illustrating how display unevenness is reduced by causing respective luminances of right and left regions to be uniform.

FIG. 29 is a set of views (a) and (b) for describing the conventional technology, (a) of FIG. 29 schematically illustrating a case where the luminance difference between right and left regions of the display screen is less than 0.5 grayscale and (b) of FIG. 29 illustrating how the display screen displays an image in a case where the image illustrated in (a) of FIG. 29 has been subjected to grayscale correction.

### DESCRIPTION OF EMBODIMENTS

The following description will discuss an embodiment of the present invention with reference to the drawings. Note that, although a liquid crystal display device (liquid crystal display) is employed in the embodiment as an example of the display device of the present invention, the display device of the present invention is not limited to such. In fact, the display device of the present invention is applicable to various types of display devices such as those including organic EL displays, plasma displays, or the like.

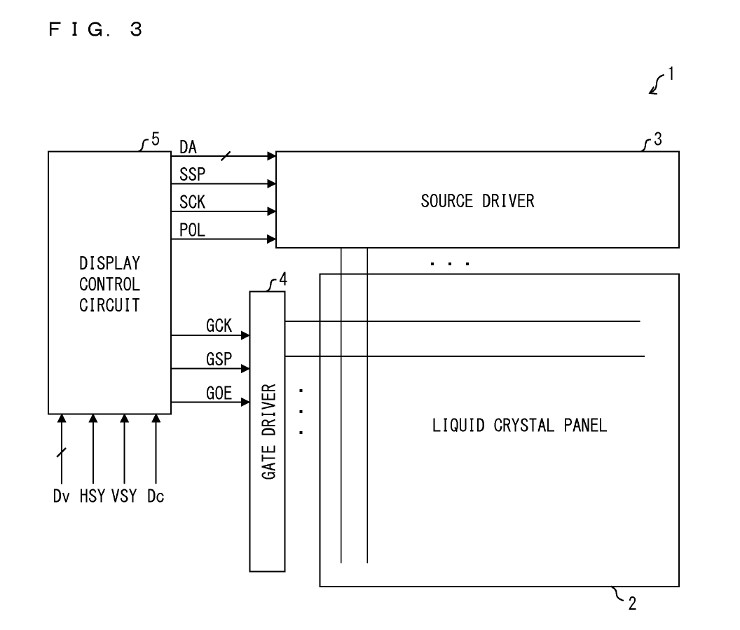

FIG. 3 is a block diagram schematically illustrating a configuration of a liquid crystal display device of the embodiment. As illustrated in FIG. 3, a liquid crystal display device 1 includes a liquid crystal panel 2 (display panel), a source driver 3 (data signal line drive circuit), a gate driver 4 (scan signal line drive circuit), and a display control circuit 5. The source driver 3 and the gate driver 4 drive data signal lines and scan signal lines, respectively. The display control circuit 5 controls the source driver 3 and the gate driver 4. Note that it is possible, as needed, to provide a CS driver (retention capacitor wiring drive circuit) for driving retention capacitor wiring.

The display control circuit 5 receives, from an external signal source (e.g. tuner), (i) a digital video signal Dv that indicates an image to be displayed, (ii) a horizontal sync signal HSY and a vertical sync signal VSY, each of which corresponds to the digital video signal Dv, and (iii) a control signal Dc for controlling a display operation. In accordance with the signals Dv, HSY, VSY, and Dc thus received, the display control circuit 5 generates, as signals for causing the image to be displayed on a display screen of the liquid crystal panel 2, (a) a data start pulse signal SSP, (b) a data clock signal SCK, (c) a digital image signal DA for indicating an image to be displayed (signal corresponding to the digital video signal Dv), (d) a gate start pulse signal GSP, (e) a gate clock signal GCK, and (f) a gate driver output control signal (scan signal output control signal) GOE. Then, the display control circuit 5 outputs these signals thus generated. Note that, for convenience, the digital video signal Dv and a digital image signal DA corresponding to the digital video signal Dv will each be referred to as “input image.” Note also that a digital image signal DA, which has been corrected based on the digital video signal Dv (input image), will be referred to as “corrected image” (described later in detail). That is, a digital image signal DA, which is outputted from the display control circuit 5, includes the input image and the corrected image (see FIG. 3).

Of the signals thus generated by the display control circuit 5, (i) the digital image signal DA (the input image and the corrected image), a signal POL for controlling a polarity of a signal potential (polarity of data signal potential), the data start pulse signal SSP, and the data clock signal SCK, are supplied into the source driver 3 and (ii) the gate start pulse signal GSP, the gate clock signal GCK, and the gate driver output control signal GOE are supplied into the gate driver 4.

In accordance with the digital signal DA, the data clock signal SCK, the data start pulse signal SSP, and the polarity inversion signal POL thus supplied, the source driver 3 sequentially generates, during respective horizontal scanning periods, analogue voltages (signal voltages) corresponding to values of respective pixels in scan signal lines of the image indicated by the digital image signal DA. Then, the source driver 3 supplies, to the data signal lines, data signals based on the analogue voltages thus generated.

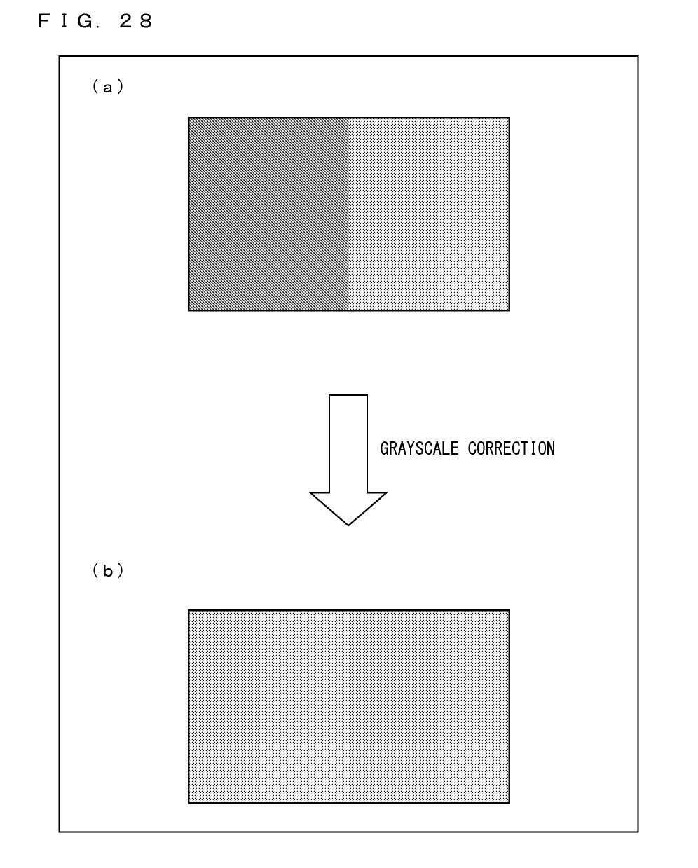

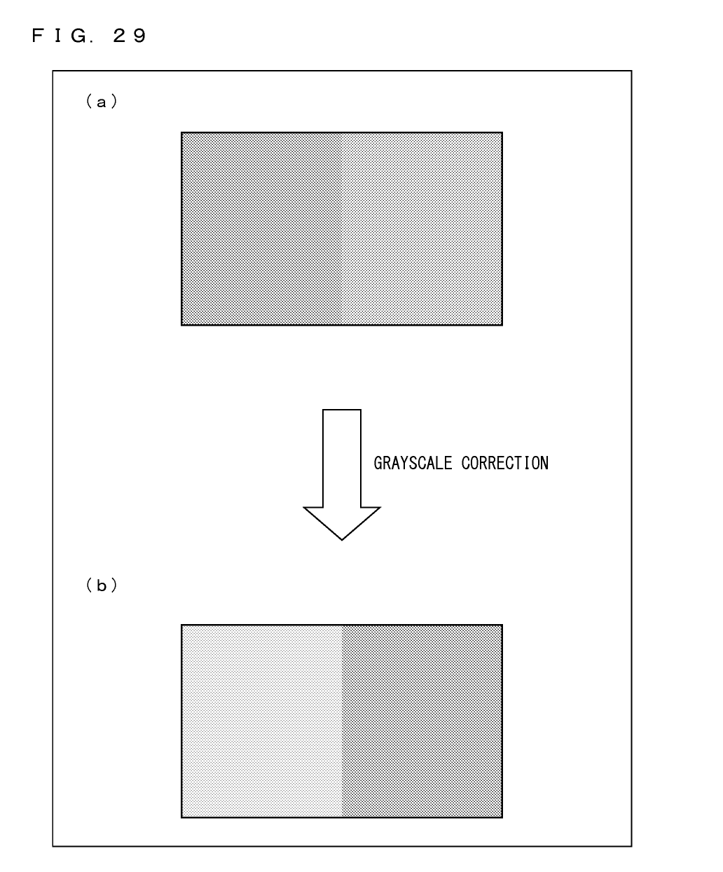

The liquid crystal display device 1 configured as such is, in particular, equipped with a function to display a corrected image which has been subjected to correction based on an input image. This allows a reduction in display unevenness (see (a) of FIG. 28 and (a) of FIG. 29) that occurs on the display screen of the liquid crystal panel 2. The details of the display control circuit 5, which generates the corrected image, will be described below.

(Configuration of Display Control Circuit 5)

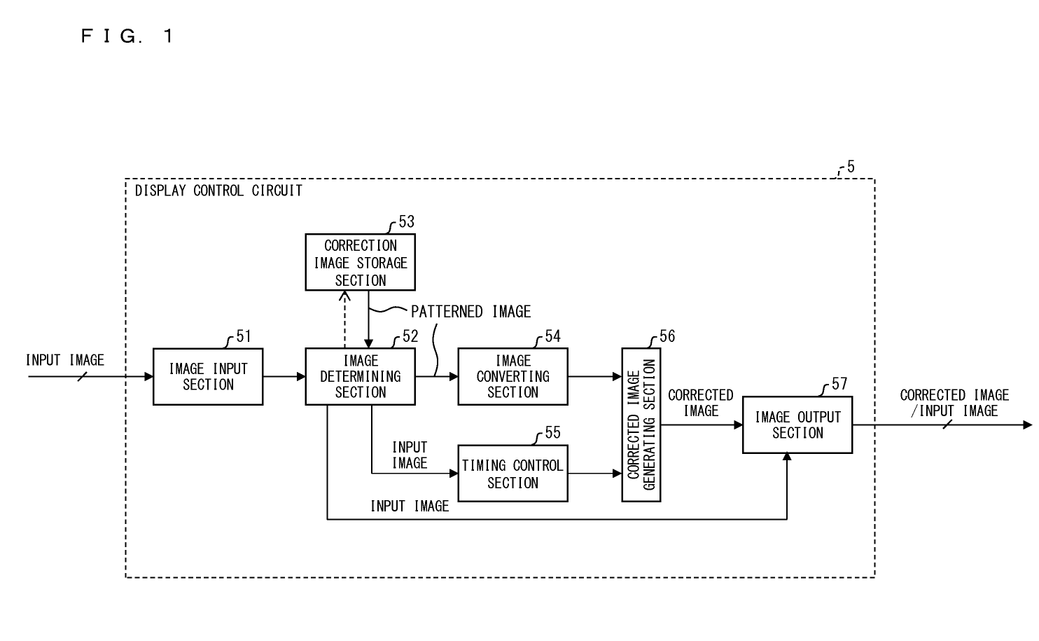

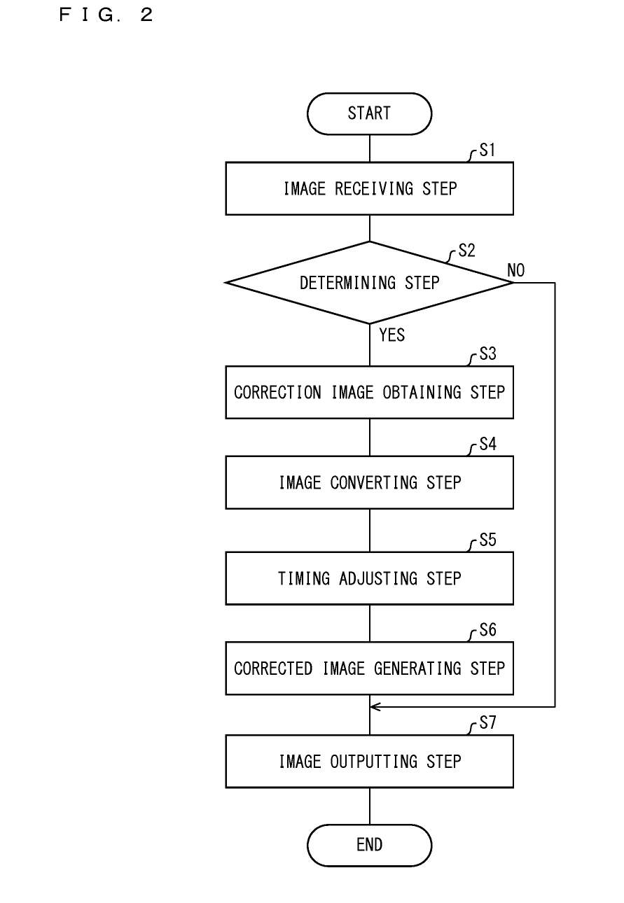

FIG. 1 is a block diagram illustrating a configuration of the display control circuit 5 in detail. As illustrated in FIG. 1, the display control circuit 5 includes an image input section 51, an image determining section 52, a correction image storage section 53, an image converting section 54, a timing control section 55, a corrected image generating section 56, and an image output section 57. Note that solid arrows illustrated in FIG. 1 each indicate a flow of an image data signal. FIG. 2 is a flow chart illustrated an operation of the display control circuit 5.

The image input section 51 receives an input image from an external signal source (e.g. tuner), and then supplies the input image to the image determining section 52 (S1: image obtaining step).

The image determining section 52 recognizes the input image thus supplied via the image input section 51, as well as determines whether or not the input image needs to be corrected (S2: determining step). In a case where the image determining section 52 determines that the input image needs to be corrected (YES in S2), the image determining section 52 (i) obtains, from the correction image storage section 53, a patterned image which corresponds to the input image thus recognized, and then supplies the patterned image to the image converting section 54 as well as (ii) supplies the input image to the timing control section 55 (S3: correction image obtaining step). On the other hand, in a case where the image determining section 52 determines that the input image does not need to be corrected (NO in S2), the image determining section 52 supplies the input to the image output section 57 without obtaining a patterned image. A specific method of the determining step of the image determining section 52 and a specific example of patterned images stored in the correction image storage section 53 will be described later.

The image converting section 54 subjects the patterned image, which has been thus received from the image determining section 52, to data conversion such as decryption, and then supplies a converted patterned image to the corrected image generating section 56 (S4: image converting step). Note that in a case where a patterned image is not of compressed data, the operation of the image converting section 54 can be skipped.

The timing control section 55 causes the input image supplied from the image determining section 52 to be delayed by an amount of time it takes for the operation of the image converting section 54. Then, the timing control section 55 supplies the input image to the corrected image generating section 56 with the same timing with which the (converted) patterned image is supplied to the corrected image generating section 56 from the image converting section 54 (S5: timing adjusting step).

In accordance with the patterned image and the input image thus supplied, the corrected image generating section generates a corrected image, and then supplies the corrected image to the image output section 57 (S6: corrected image generating step).

In accordance with a horizontal sync signal HSY, a vertical sync signal VSY, and a control signal Dc, the image output section 57 supplies the corrected image to the source driver 3 (S7: image outputting step).

In the case where the image determining section 52 determines that the input image supplied from the external signal source does not need to be corrected (NO in S2), the display control circuit 5 supplies the input image to the source driver 3 without correcting the input image supplied from the image determining section 52 (S7: image outputting step).

The following description will discuss specific examples (Examples 1 through 5) of (i) a patterned image and (ii) a corrected image to be generated in accordance with the patterned image. Note that, for convenience, an input image supplied from an external signal source is a solid image that fills the entire display screen with a uniform pattern. Note also that the liquid crystal display device 1 has a structure in which two color filters are arranged side by side (right and left).

In a case where two color filters are arranged side by side (right and left), a recognizable boundary (highlighting a luminance difference) is recognized at a part of a display screen of a display panel, at which part the right and left color filters are joined together (see (a) of FIG. 28 and (a) of FIG. 29). In addition, in a case where the luminance difference between the right color filter and the left color filter is smaller than 0.5 grayscale as illustrated in (a) of FIG. 29, conventional grayscale correction causes the luminance difference to be large as illustrated in (b) of FIG. 29. This causes display quality to be even lower than it was before the grayscale correction.

According to the liquid crystal display device 1, in contrast, patterned images described in Examples 1 through 5 are employed. This causes a luminance boundary to be unnoticeable, and therefore allows an increase in display quality.

### Example 1

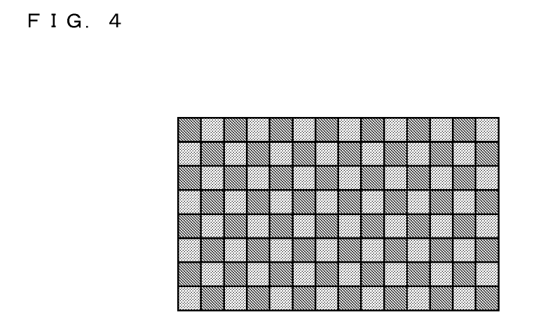

FIG. 4 illustrates how the display screen displays a corrected image in accordance with Example 1. As illustrated in FIG. 4, the corrected image corresponds to a check-patterned image. Note that each square illustrated in FIG. 4 (and in subsequent drawings as well) corresponds to each pixel.

A method of generating a corrected image illustrated in FIG. 4 will be described below in detail.

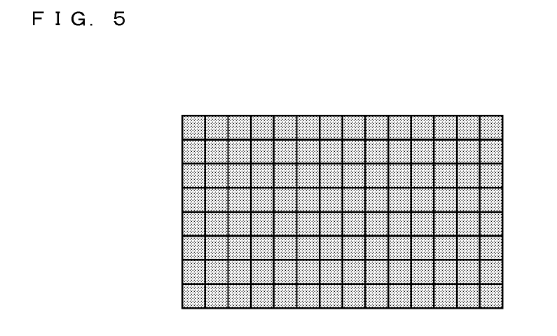

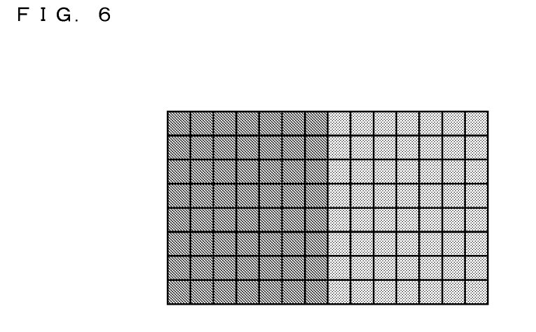

First, an input image (illustrated in FIG. 5) having A grayscale, for example, is supplied from an external signal source into the image input section 51. FIG. 6 illustrates how the display screen displays an image which has not been subjected to grayscale correction.

Next, the image determining section 52 determines whether or not the input image needs to be corrected. Specifically, the image determining section 52 (i) determines that grayscale correction is “necessary” in a case where A grayscale is equal to or less than a predetermined grayscale and (ii) determines that grayscale correction is “unnecessary” in a case where A grayscale is greater than the predetermined grayscale.

Note that since a luminance difference on the display screen is noticeable if a grayscale is in a low range (dark range), a predetermined grayscale is preferably set to a low grayscale value. For example, a predetermined grayscale is set to 31 grayscale in a case where (i) a liquid crystal display device having a maximum grayscale of 255 is employed and (ii) a luminance difference is noticeable when a displayed image is in the range of 0 grayscale to 31 grayscale. Note that a predetermined grayscale can be preset in accordance with a noticeability level of a luminance boundary, which noticeability level is determined by characteristics (such as color filter characteristic, viewing angle characteristic, and temperature characteristic) of the liquid crystal panel 2. According to Example 1, the predetermined grayscale is set to 31 grayscale.

Next, in a case where A grayscale of the input image is low (A grayscale ≦31 grayscale), the image determining section 52 (i) determines that the grayscale correction of the input image is “necessary”, (ii) obtains a patterned image, which corresponds to the input image, from the correction image storage section 53, and then (iii) supplies the patterned image to the image converting section 54. At the same time, the image determining section 52 supplies the input image to the timing control section 55.

Note that a patterned image is configured by arranging, in a mixed manner, pixels each having one of two different grayscales. The patterned image of Example 1 is configured to be a check-patterned image by alternating, in a vertical and/or horizontal direction(s), the pixels of two different grayscales across the entire display screen. The two different grayscales can be, for example, (i) A grayscale of the input image and (ii) A 1 grayscale (A1 grayscale=A grayscale±α grayscale) which is set in accordance with the characteristic of the color filters.

Note that A1 grayscale can be preset. Specifically, an image having A grayscale is displayed on the liquid crystal display device without carrying out grayscale correction, and respective luminances of the right-half region and the left-half region are measured. Then, in a case where the luminance of one of the regions is lower than an intended luminance (corresponding to A grayscale), A1 grayscale is set to a value higher than A grayscale (i.e. A1 grayscale=A grayscale+α grayscale) so that the luminance of one of the region is increased. On the other hand, in a case where the luminance of one of the regions is higher than the intended luminance (corresponding to A grayscale), A1 grayscale is set to a value lower than A grayscale (i.e. A1 grayscale=A grayscale−α grayscale) so that the luminance of one of the regions is decreased. A1 grayscale can be thus preset in accordance with the characteristics (such as color filter characteristic, viewing angle characteristic, and temperature characteristic) of the liquid crystal panel 2. This allows a plurality of patterned images, each of which is preset to correspond to an input image, to be stored in the correction image storage section 53.

Alternatively, it is also possible to configure, without using A grayscale corresponding to the input image, the two different grayscales of the patterned image to be A1 grayscale (A1 grayscale=A grayscale±α grayscale) and A2 grayscale (A2 grayscale=A grayscale±β grayscale) which are set in accordance with the respective characteristics of the color filters. Furthermore, it is also possible to configure the patterned image by arranging, in a mixed manner, pixels each having one of three or more differing grayscales.

Subsequently, the patterned image, which has been supplied to the image converting section 54, is subjected to data conversion such as decryption, and is then supplied to the corrected image generating section 56. Meanwhile, the input image, which has been supplied to the timing control section 55, is subjected to a timing adjustment, and is then supplied to the corrected image generating section 56.

In accordance with the patterned image and the input image thus supplied, the corrected image generating section 56 generates a corrected image. Specifically, the corrected image generating section 56 can generate a corrected image by subjecting the patterned image and the input image to addition and subtraction. Then, the corrected image thus generated is supplied to the source driver 3 via the image output section 57, and then a normal display operation is executed. This causes the image illustrated in FIG. 4 to be displayed. According to Example 1, a solid image is displayed across the entire display screen, and therefore the corrected image corresponds to the patterned image.

With the grayscale correction, the respective luminances of the right and left regions of the display screen illustrated in FIG. 6 are made uniform. This allows a luminance boundary, which appears at a center part of the display screen, to be unnoticeable.

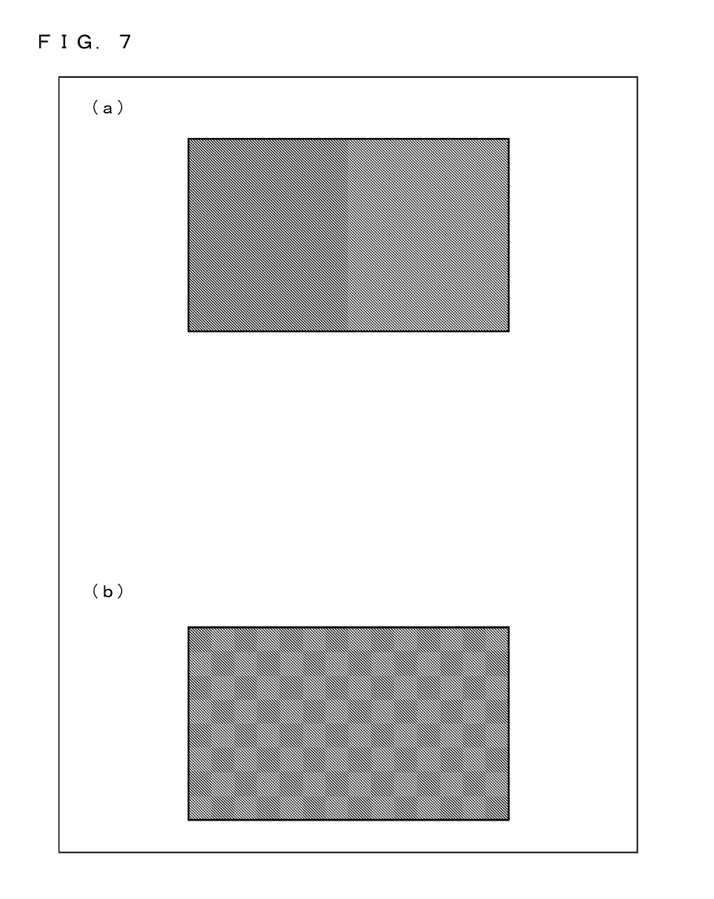

Note that, although FIG. 6 illustrates a large luminance difference between the right and left regions for convenience, the grayscale correction of an image is particularly effective in a case where a luminance difference is small (for example, in a case where a grayscale difference is equal to or less than 0.5 grayscale). (a) of FIG. 7 illustrates an image in a case where the luminance difference between the right and left regions of the display screen of FIG. 6 is small. (b) of FIG. 7 schematically illustrates how the display screen displays a corrected image that corresponds to the image illustrated in (a) of FIG. 7. It is perceivable that, while the luminance boundary stands out at the center part of the display screen of (a) of FIG. 7, the luminance boundary does not stand out at the center part of the display screen of (b) of FIG. 7 since the respective luminances of the right and left regions are made uniform in (b) of FIG. 7.

Note that, in a case where A grayscale of the input image is higher than 31 grayscale (i.e. A grayscale>31 grayscale) in the grayscale correction, the image determining section 52 determines that the grayscale correction of the input image is “unnecessary”, and then supplies the input image to the image output section 57. This causes an image, which is based on the input image having a grayscale corresponding to A grayscale, to be displayed.

With the liquid crystal display device 1, unlike the conventional cases in which grayscales of the entire part of a predetermined region is corrected, display unevenness caused by a minimal luminance difference can be thus reduced by the grayscale correction in which a patterned image is displayed.

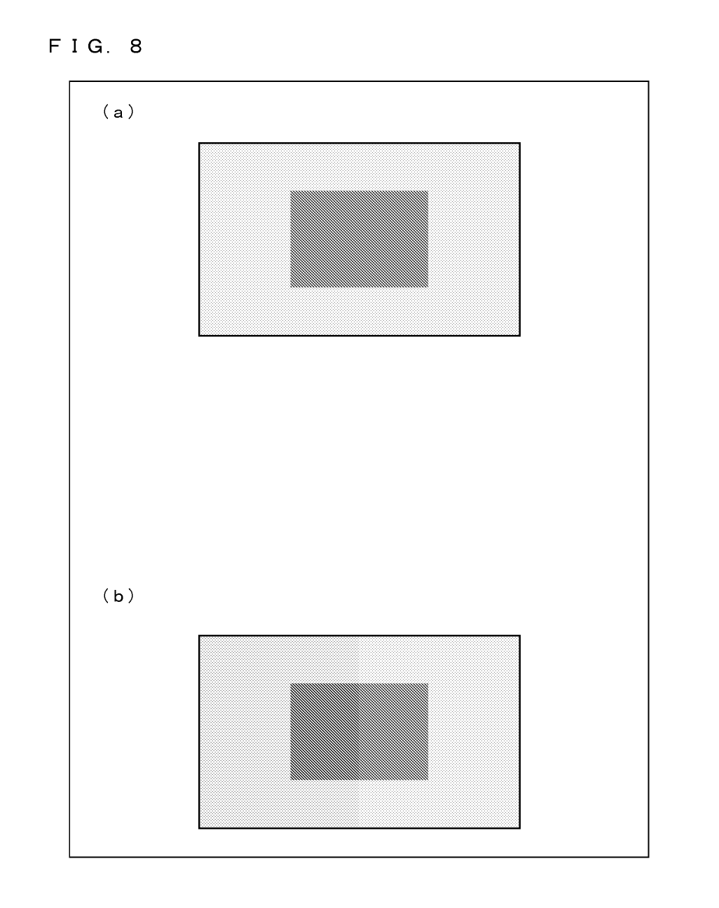

Note that, although the above description discussed an example in which a solid image is displayed across the entire display screen, the present embodiment is not limited to such. In fact, the present embodiment is applicable to a case where an image of a uniform grayscale is displayed on a part of a display screen (see (a) of FIG. 8). (a) of FIG. 8 illustrates an image to be displayed, the image being configured so that there is a difference in luminance (grayscale) between (i) a central region of a display screen and (ii) an outer region of the display screen by which the central region is surrounded. In a case where the image is not subjected to the grayscale correction, a vertical luminance boundary becomes recognizable across respective center parts (between right and left regions) of the central region and of the outer region (see (b) of FIG. 8).

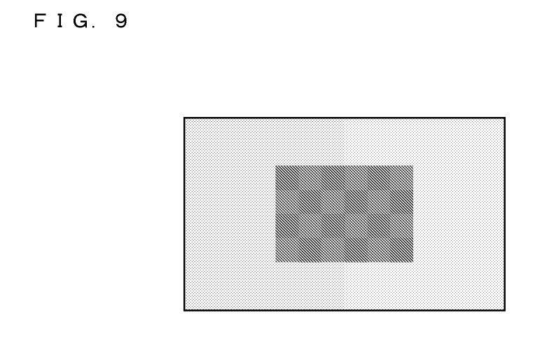

According to the image illustrated in (b) of FIG. 8, (i) the luminance boundary across the outer region is not noticeable because of its high grayscale (input grayscale > predetermined grayscale (31 grayscale)), and the outer region is therefore not to be subjected to the grayscale correction and (ii) the luminance boundary across the central region is noticeable because of its low grayscale (input grayscale predetermined grayscale (31 grayscale)), and the central region is therefore to be subjected to the grayscale correction. This causes a patterned image (check pattern) to be displayed only on the central region as illustrated in FIG. 9, and therefore allows an overall luminance boundary across the entire display screen to be unnoticeable.

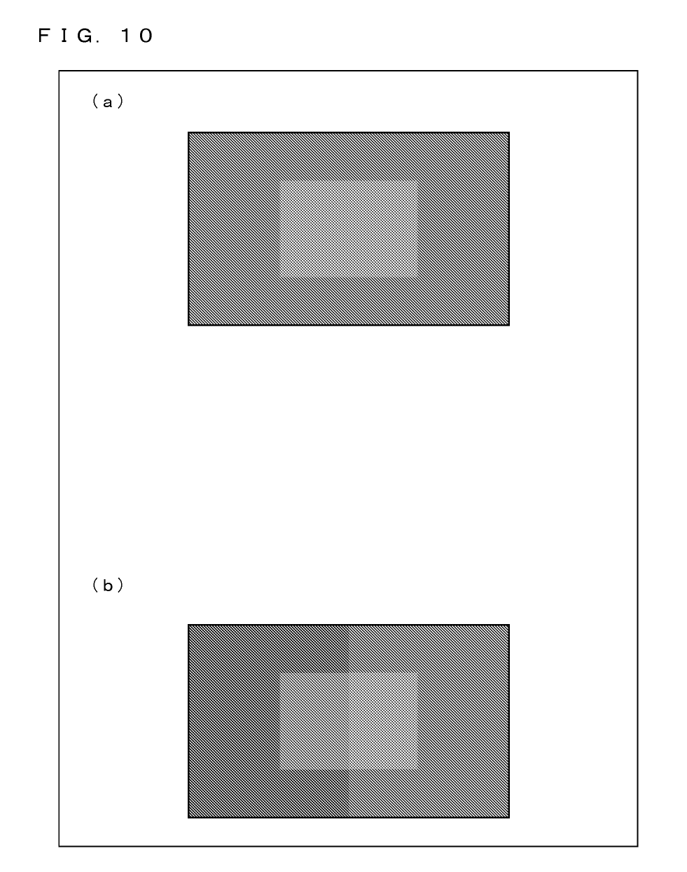

(a) of FIG. 10 illustrates an image to be displayed, the image being configured so that (I) there is a difference in luminance (grayscale) between (i) a central region of a display screen and (ii) an outer region of the display screen by which the central region is surrounded and (II) an overall grayscale of the image is low. In a case where the image is not subjected to the grayscale correction, a vertical luminance boundary becomes recognizable across respective center parts (between right and left regions) of the central region and of the outer region (see (b) of FIG. 10).

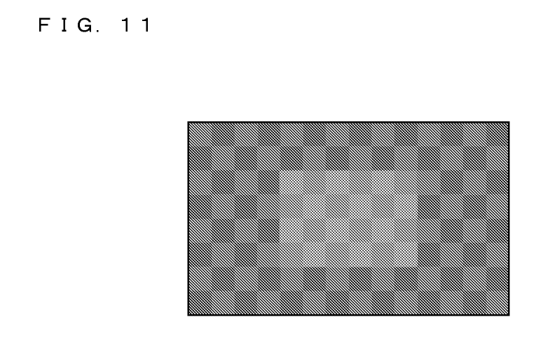

For such an image, the entire display screen is to be subjected to the grayscale correction. This causes a patterned image (check pattern) to be displayed on the central region and the outer region as illustrated in FIG. 11, and therefore allows an overall luminance boundary across the entire display screen to be unnoticeable.

Note that the correction image storage section 53 can be configured by an LUT in which respective grayscales of an input image and a patterned image are associated with each other in advance. Alternatively, it is also possible to store, in the correction image storage section 53, a correction parameter that corresponds to a grayscale of an input image. In a case where a correction parameter is used, the corrected image generating section 56 generates a corrected image in accordance with an input image and the correction parameter. Patterned images of the present invention encompass (i) an image stored in the correction image storage section 53 in advance and (ii) an image corresponding to a correction parameter.

Furthermore, the correction image storage section 53 can be configured to include (i) a FRASH/EEPROM which stores a patterned image therein and is a non-volatile memory and (ii) a DRAM which is capable of fast access to the FRASH/EEPROM and is a non-volatile memory. According to such a correction image storage section 53, a patterned image is downloaded from the FRASH/EEPROM after the liquid crystal display device 1 is powered up, and then the patterned image is stored in the DRAM. Alternatively, it is also possible to provide an FRASH/EEPROM outside the display control circuit 5.

The following description will discuss grayscale correction of an image in accordance with another example. Note that, for convenience, members similar in function to the members described in Example 1 will be given the same reference signs, and their description will be omitted. Note also that the terms, the definitions of which were provided in Example 1, will be used under the same definitions in the subsequent examples unless stated otherwise.

### Example 2

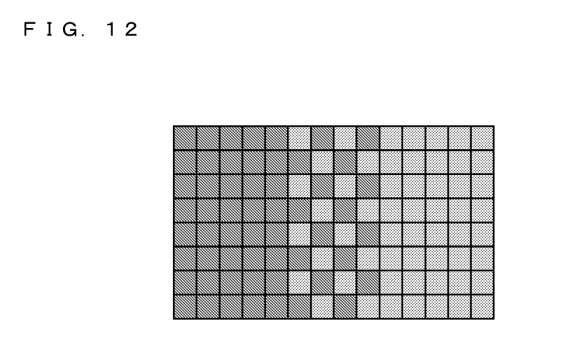

FIG. 12 illustrates how a display screen displays a corrected image in accordance with Example 2. As illustrated in FIG. 12, only a center part of the corrected image, which center part includes a luminance boundary, is configured to be a patterned image (check pattern).

According to the configuration, the patterned image is displayed on a region which (i) is part of the display screen and (ii) includes the luminance boundary. This allows at least the luminance boundary to be unnoticeable. Grayscale correction in accordance with Example 2 is particularly effective in a case where a luminance difference between right and left regions of the display screen is small.

Since only the region including the luminance boundary is subjected to the grayscale correction, it is possible to minimize side effects of the grayscale correction. The following is an example of the side effects: In a case where (i) an 8-bit source driver is artificially realized as a 10-bit source driver (with 2 bits of pseudo-grayscale) and (ii) no grayscale correction is carried out, a display device is capable of rendering an image having 1020 grayscale. However, in a case where the display device is set such that 124 grayscale of an input image is corrected to 126 grayscale, 125 grayscale to 1020 grayscale of an input image is corrected to 127 grayscale to 1020 grayscale. This causes the grayscale of an output image to be lower than the grayscale of an input image, and therefore reduce the grayscale rendering performance. In this regard, according to the above configuration, part of the display screen is subjected to grayscale correction, and it is therefore possible to minimize a reduction in the grayscale rendering performance.

(Modification of Example 2)

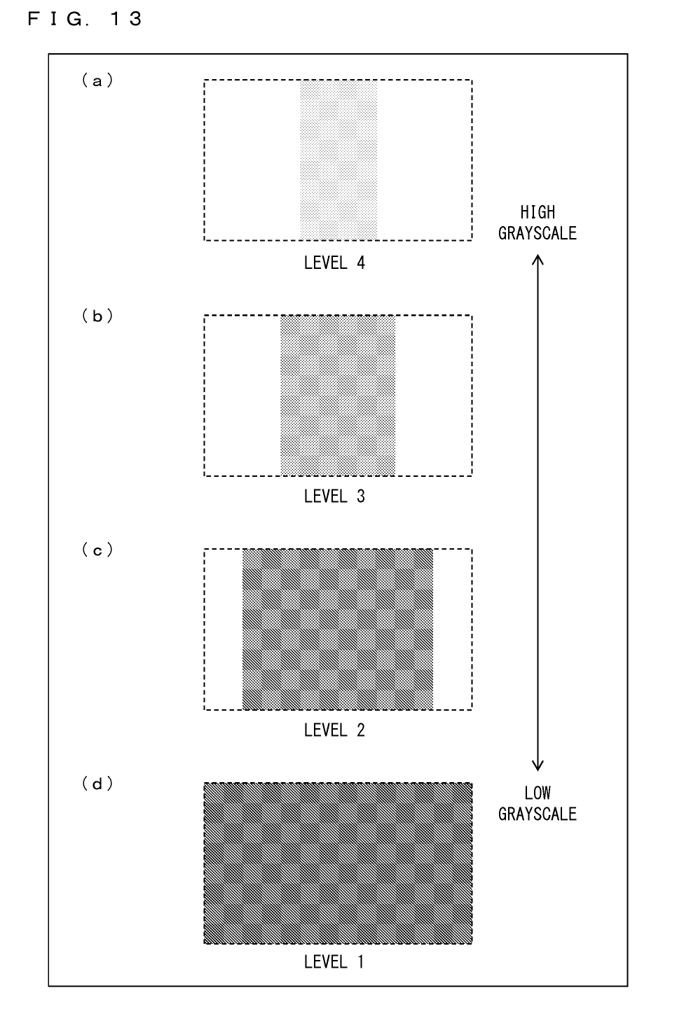

Note that a luminance difference between right and left regions of a display screen varies, depending on a grayscale of an input image. For example, a lower grayscale of an input image leads to a larger luminance difference, and a higher grayscale of an input image leads to a smaller luminance difference. In view of the circumstances, it is possible to configure the display device so that a range, in which a patterned image is to be displayed, is changed according to the grayscale of an input image. Specifically, in a case where an input image having a low grayscale is supplied, a patterned image is displayed across the entire display screen as in Example 1 (see FIG. 4). On the other hand, in a case where an input image having a high grayscale is supplied, a patterned image is displayed only on a center part of the display screen as in Example 2 (see FIG. 12). Note that such grayscale correction can be achieved by (i) causing patterned images corresponding to respective grayscale levels to be stored in the correction image storage section 53 in advance and (ii) causing the image determining section 52 to determine a grayscale level of an input image. (a) through (d) of FIG. 13 illustrate patterned images corresponding to respective grayscale levels of an input image. A grayscale is, for example, classified into four different level (the higher a grayscale, the higher a level), and (I) a patterned image illustrated in (a) of FIG. 13 is selected in a case where the grayscale of the input image falls under a level 4 (maximum grayscale), (II) a patterned image illustrated in (b) of FIG. 13 is selected in a case where the grayscale falls under a level 3, (III) a patterned image illustrated in (c) of FIG. 13 is selected in a case where the grayscale falls under a level 2, and (IV) a patterned image illustrated in (d) of FIG. 13 is selected in a case where the grayscale falls under a level 1 (minimum grayscale). According to this configuration, a range, in which a corrected image is to be displayed, can be changed according to the grayscale of an input image, and therefore efficient grayscale correction is possible.

Note that other operations to be executed in the display control circuit 5 are similar to those described in Example 1, and therefore their descriptions will be omitted.

### Example 3

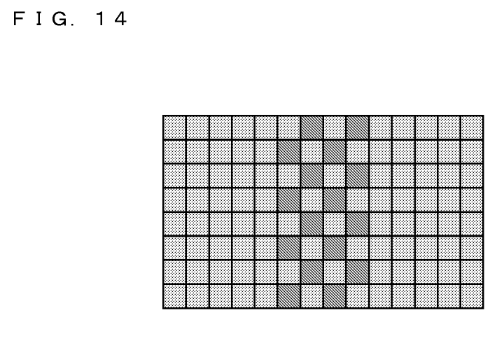

FIG. 14 illustrates how a display screen displays a corrected image in accordance with Example 3. As illustrated in FIG. 14, (i) a center part of the corrected image, which center part includes a luminance boundary, is configured to be a patterned image (check pattern) and (ii) the rest of the corrected image is configured to be an image (grayscale-corrected image) which has been subjected to grayscale correction.

According to the configuration, (i) the patterned image is displayed on a region which is part of the display screen and which includes the luminance boundary, and it is therefore possible to cause the luminance boundary to be unnoticeable and (ii) the other regions, which are susceptible to display unevenness, are subjected to grayscale correction, and it is therefore possible to cause an overall luminance across the entire display screen to be uniform. Grayscale correction in accordance with Example 3 is particularly effective in a case where a luminance difference between right and left regions of the display screen is large (i.e. in a case where the luminance difference is equal to or greater than 1 grayscale or more).

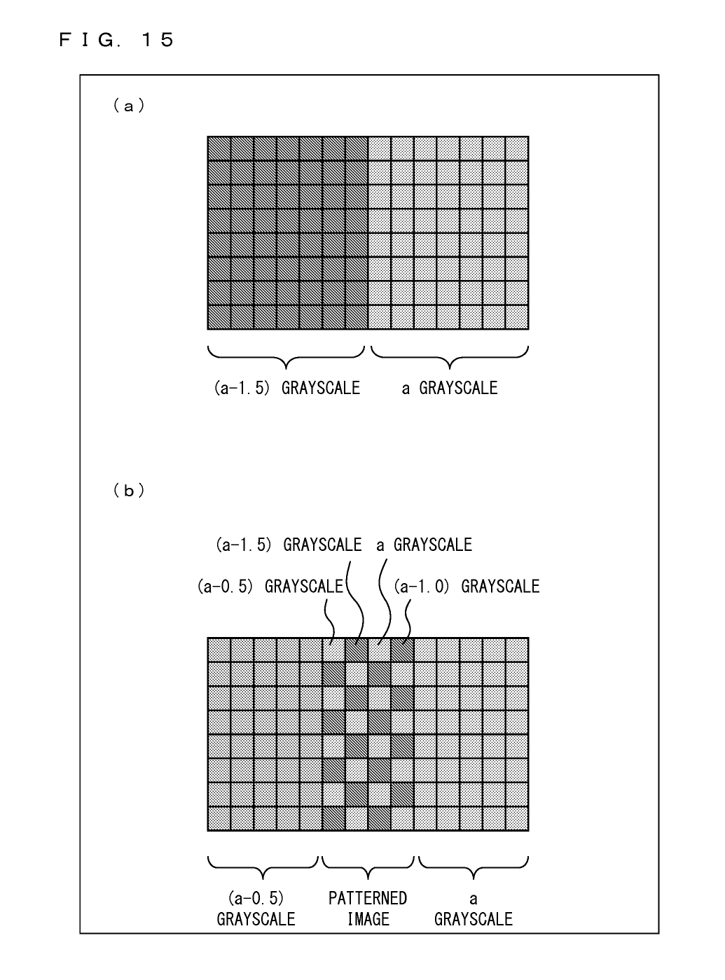

The following is a specific example of the configuration: Assume that (i) an input image (solid image) has a grayscale and (ii), in a case where grayscale correction is not carried out, a right-half region of the display screen has a luminance corresponding to a grayscale whereas a left-half region of the display screen has a luminance (darker than the luminance of the right-half region) corresponding to (a−1.5) grayscale, as illustrated in (a) of FIG. 15. Specifically, the right-half region displays an image having an intended luminance whereas the left-half region displays an image having a luminance which is lower (darker) than the luminance of the right-half region by a luminance corresponding to 1.5 grayscales.

In this case, with respect to a patterned image displayed on a central region, for example, (i) an image displayed on a left part of the central region, which left part overlaps the left-half region, is made up of pixels each having a grayscale of an input image (a grayscale) and pixels each having (a+1.0) grayscale and (ii) an image displayed on a right part of the central region, which right part overlaps the right-half region, is made up of pixels each having the grayscale of the input image (a grayscale) and pixels each having (a−1.0) grayscale. This, as illustrated in (b) of FIG. 15, (I) causes the luminance of the left part to be lowered by an amount corresponding to 1.5 grayscales, and therefore causes the left part to be presented with a luminance corresponding to (a−1.5) grayscale and with a luminance corresponding to (a−0.5) grayscale and (II) causes the luminance of the right part to remain the same, and therefore causes the right part to be presented with a luminance corresponding to a grayscale and with a luminance corresponding to (a−1.0) grayscale.

In addition, a part of the left-half region, which part does not overlap the left part, displays an image whose grayscale has been changed from the grayscale of the input image (a grayscale) to (a+1.0) grayscale whereas a part of the right-half region, which part does not overlap the right part, displays an image having a grayscale without carrying out grayscale correction. This, as illustrated in (b) of FIG. 15, (I) causes the luminance of the part of the left-half region to be lowered by an amount corresponding to 1.5 grayscales, and therefore causes the part of the left-half region to be presented with the luminance corresponding to (a−0.5) grayscale and (II) causes the part of the right-half region to be presented with the luminance corresponding to a grayscale. Alternatively, with respect to the part of the left-half region, the grayscale of the input image (a grayscale) can be corrected to be (a+2.0) grayscale. In such a case, on the display screen, the part of the left-half region after such grayscale correction is presented with a luminance corresponding to (a+0.5) grayscale.

Note that a commonly-known technology can be employed for the grayscale correction. Note also that the configuration for the patterned images illustrated in FIG. 13 can be employed in Example 3.

### Example 4

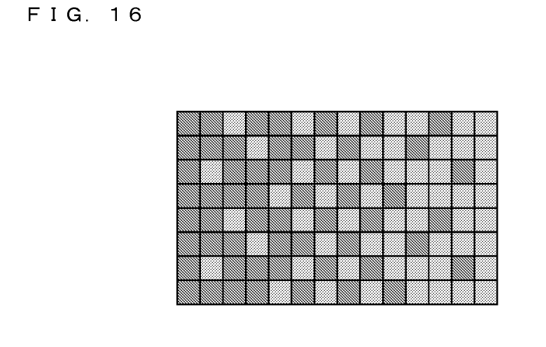

FIG. 16 illustrates how a display screen displays a corrected image in accordance with Example 4. As illustrated in FIG. 16, the corrected image is configured to be a patterned image displayed schematically across the entire display screen. The patterned image is configured so that (i) an image displayed on a center part of the display screen, which center part includes a luminance boundary, is a check-patterned image (in which pixels each having one grayscale and pixels each having another grayscale are alternated) and (ii) an image displayed on the rest of the display screen is an image presented so that a longer distance from the pixels to the center part is relative to a lower mixture rate of the pixels of one and the other grayscales.

This configuration allows the luminance boundary to be unnoticeable as well as allows an overall luminance across the entire display screen to be uniform.

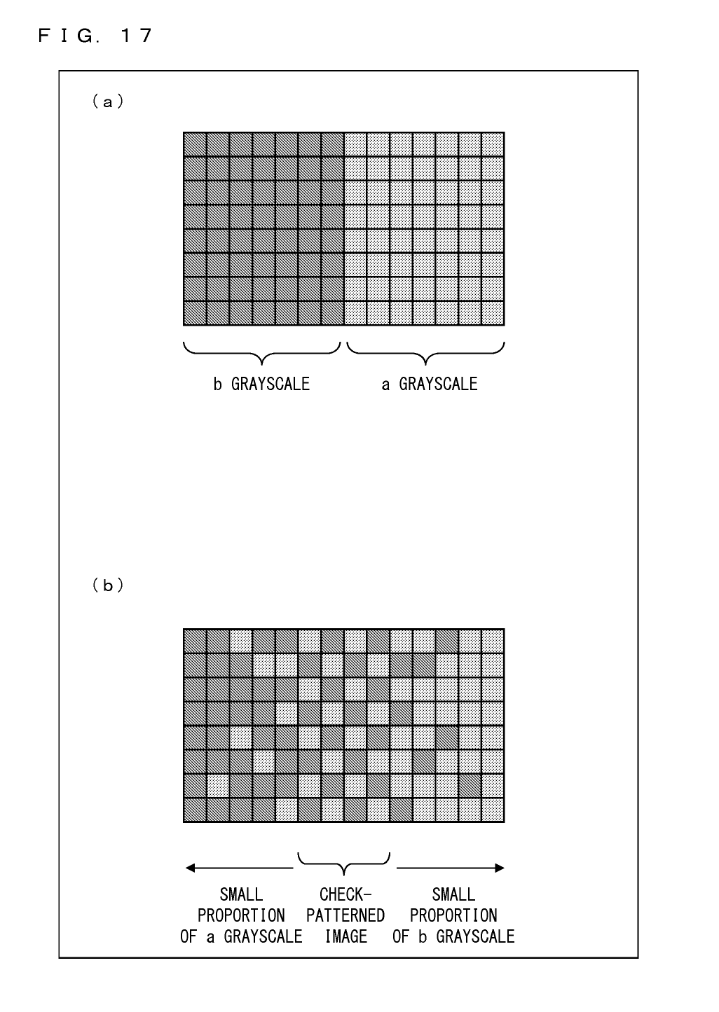

The following is a specific example of the configuration: Assume that (i) an input image (solid image) has a grayscale and (ii), in a case where grayscale correction is not carried out, a right-half region of the display screen has a luminance corresponding to a grayscale whereas a left-half region of the display screen has a luminance corresponding to b grayscale (see (a) of FIG. 17). In this case, as illustrated in (b) of FIG. 17, (I) a center part, which includes a luminance boundary, displays a check pattern (check-patterned image) made up of pixels each having a grayscale (such pixels are hereinafter referred to as a-grayscale pixels) and of pixels each having b grayscale (such pixels are hereinafter referred to as b-grayscale pixels), (II) a left-half region is presented so that the closer to a left end part of the display screen (the farther from the center part), the lower a ratio (i.e. mixture ratio) of the a-grayscale pixels per given surface area, and (III) a right-half region is presented so that the closer to a right end part of the display screen (the farther from the center part), the lower a ratio (i.e. mixture ratio) of the b-grayscale pixels to the a-grayscale pixels.

Note that the mixture rate, at which the a-grayscale pixels and the b-grayscale pixels are mixed, can be set according to a grayscale of an input image. For example, in a case where an input image has a low grayscale that causes a large luminance difference between the right and left regions of the display screen, the mixture rate is to be made large (e.g. a large amount of the a-grayscale pixels are to be presented in the left-half region illustrated in (b) of FIG. 17). On the other hand, in a case where an input image has a high grayscale that causes a small luminance difference between the right and left regions of the display screen, the mixture rate is to be made small (e.g. a small amount of the a-grayscale pixels are to be presented in the left-half region illustrated in (b) of FIG. 17).

Note also that an image displayed on the center part is not limited to a check-patterned image. That is, the corrected image in accordance with Example 4 can be configured so that a longer distance from the luminance boundary is relative to a lower mixture rate of the a-grayscale pixels and the b-grayscale pixels. Alternatively, it is also possible to configure the patterned image by arranging, in a mixed manner, pixels each having one of three or more differing grayscales.

### Example 5

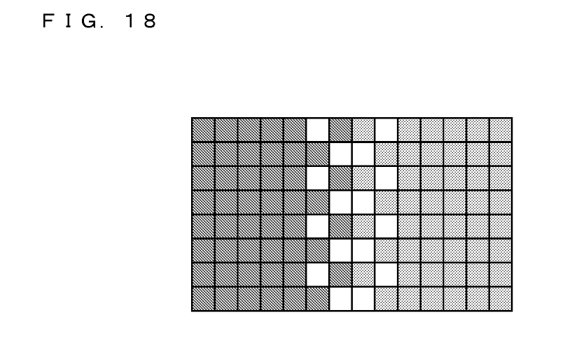

FIG. 18 illustrates how a display screen displays a corrected image in accordance with Example 5. As illustrated in FIG. 18, the corrected image is configured to be a patterned image in which a region, which includes at least a luminance boundary, has (i) a grayscale of an input image, (ii) a grayscale corresponding to a luminance of the display screen, and (iii) a grayscale (particularly a high grayscale) that is different from the grayscales of (i) and (ii).

This configuration (i) allows the luminance boundary to be unnoticeable and (ii) allows for an increase in display quality of a region which is low in grayscale.

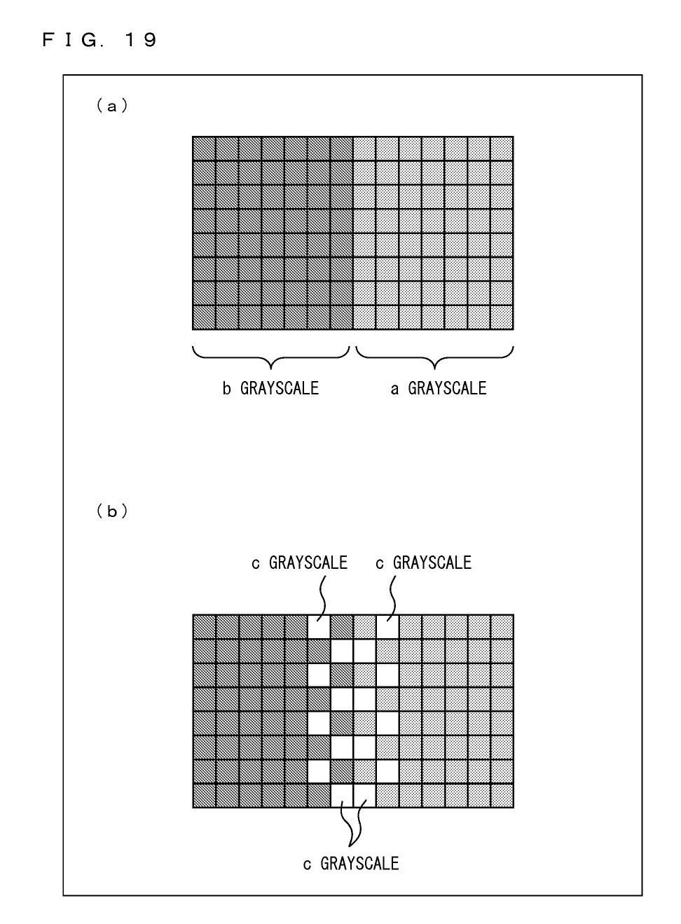

The following is a specific example of the configuration: Assume that (i) an input image (solid image) has a grayscale and (ii), in a case where grayscale correction is not carried out, a right-half region of the display screen has a luminance corresponding to a grayscale whereas a left-half region of the display screen has a luminance corresponding to b grayscale (see (a) of FIG. 19). In this case, as illustrated in (b) of FIG. 19, a center part, which includes a luminance boundary, displays a patterned image made up of c grayscale (which is higher than a grayscale and b grayscale). Note that c grayscale is set according to the grayscale of the input image. That is, c grayscale can be (a+1) grayscale or (a+2) grayscale.

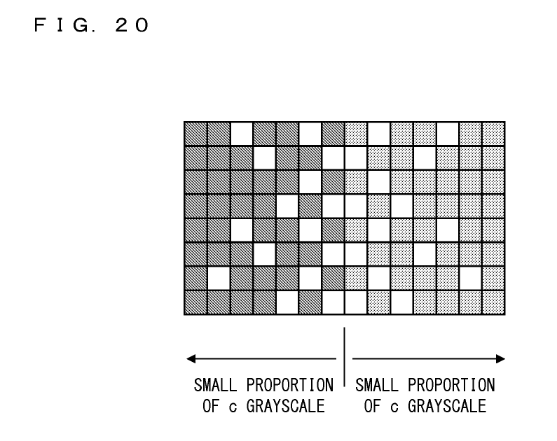

Alternatively, the patterned image in accordance with Example 5 can be configured so that a longer distance from the luminance boundary is relative to a lower ratio of pixels, each of which has c grayscale, to other pixels (see FIG. 20).

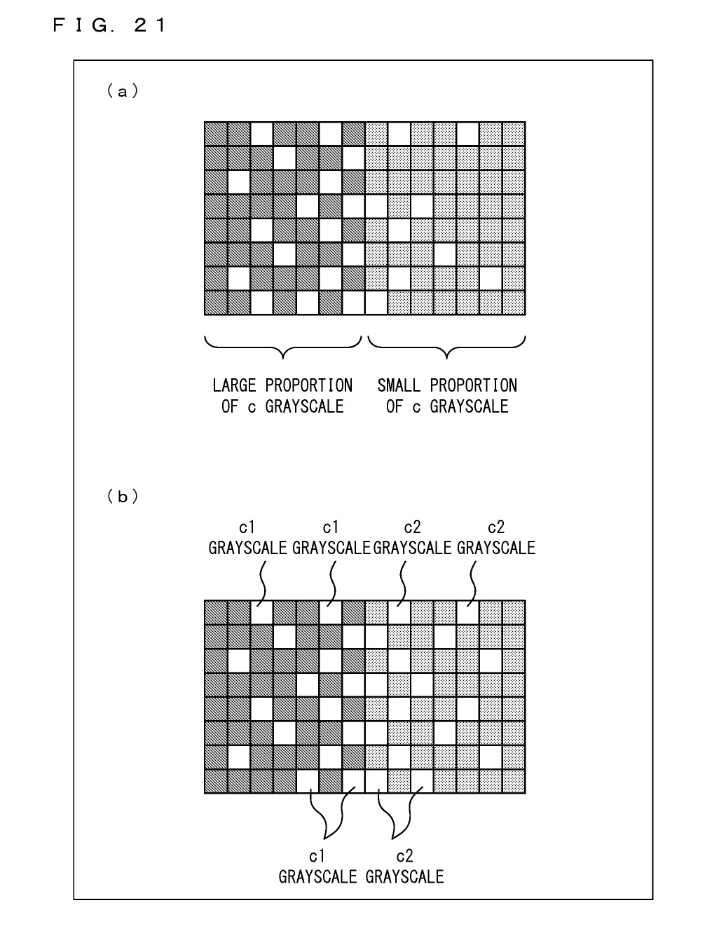

Furthermore, the patterned image in accordance with Example 5 can be set according to (i) a luminance difference between right and left regions and (ii) a grayscale of an input image. For example, in a case where a luminance on the left-half region is low (dark), it is possible to configure the patterned image so that (I) a ratio of pixels, each of which has c grayscale, to other pixels is larger on the left-half region than it is on the right-half region (see (a) of FIG. 21), (II) pixels, each of which has c1 grayscale, are provided on the left-half region whereas pixels, each of which has c2 grayscale, are provided on the right-half region (wherein c1 grayscale > c2 grayscale) (see (b) of FIG. 21), and (III) the configurations (I) and (II) are both employed in combination.

(Luminance Boundary)

The above description discussed the examples in each of which the luminance boundary is defined by a part of the display screen, at which part the right and left color filters are joined together. However, the luminance boundary, which corresponds to a predetermined region of the present invention, is not limited to such. The following description will discuss configuration examples of a liquid crystal display device in which a luminance boundary may appear on a display screen.

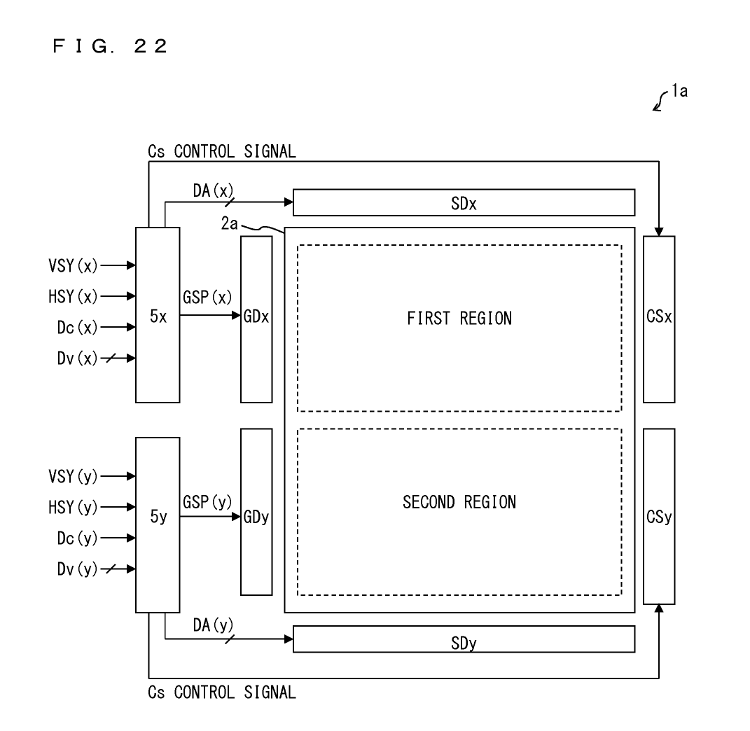

FIG. 22 is a block diagram schematically illustrating a configuration of a liquid crystal display device in accordance with anther configuration example of the present embodiment. As illustrated in 22, a liquid crystal display device 1a includes (i) a liquid crystal panel 2a made up of a first region and a second region, (ii) a first display control circuit 5x, (iii) a first source driver SDx, (iv) a first gate driver GDx, (v) a first Cs (retention capacitor wiring) control circuit CSx, (vi) a second display control circuit 5y, (vii) a second source driver SDy, (viii) a second gate driver GDy, and (ix) a second Cs control circuit CSy. Note that (A) the first display control circuit 5x, the first source driver SDx, the first gate driver GDx, and the first Cs control circuit CSx are members for driving the first region and (B) the second display control circuit 5y, the second source driver SDy, the second gate driver GDy, and the second Cs control circuit CSy are members for driving the second region.

The first display control circuit 5x receives, from an external signal source (e.g. tuner), (i) a digital video signal Dv(x) that indicates an image to be displayed, (ii) a horizontal sync signal HSY(x) and a vertical sync signal VSY(x), each of which corresponds to the digital video signal Dv(x), and (iii) a control signal Dc(x) for controlling a display operation. The second display control circuit 5y receives, from the external signal source (e.g. tuner), (i) a digital video signal Dv(y) that indicates an image to be displayed, (ii) a horizontal sync signal HSY(y) and a vertical sync signal VSY(y), each of which corresponds to the digital video signal Dv(y), and (iii) a control signal Dc(y) for controlling a display operation.

The first display control circuit 5x (i) supplies, to the first gate driver GDx, a gate start pulse signal GSP(x) and the like intended for the first region and (ii) supplies, to the first Cs control circuit CSx, a Cs control signal intended for the first region. The second display control circuit 5y supplies, to the second gate driver GDy, a gate start pulse signal GSP(y) and the like intended for the second region and (ii) supplies, to the second Cs control circuit CSy, a Cs control signal intended for the second region. The first Cs control circuit CSx supplies a Cs signal (retention capacitor wiring signal) to each of retention capacitor wires provided in the first region. The second Cs control circuit CSy supplies a Cs control signal to each of retention capacitor wires provided in the second region. The first display control circuit 5x supplies, to the first source driver SDx, the signals illustrated in FIG. 3 which signals include a digital image signal DA(x). The second display control circuit 5y supplies, to the second source driver SDy, the signals illustrated in FIG. 3 which signals include a digital image signal DA(y).

The liquid crystal panel 2a has what is known as a top-bottom division single-source structure in which (i) one (single) data signal line is provided so as to correspond to an upper part of a single line of pixels (an upstream side of a panel) and (ii) one (single) data signal line is provided so as to correspond to a lower part of the single line of pixels (a downstream side of the panel) (i.e. a structure in which (a) two (upper and lower) data signal lines are provided for a single line of pixels and (b) two scan signal lines are to be simultaneously selected). This allows the liquid crystal panel 2a to be driven at double speed.

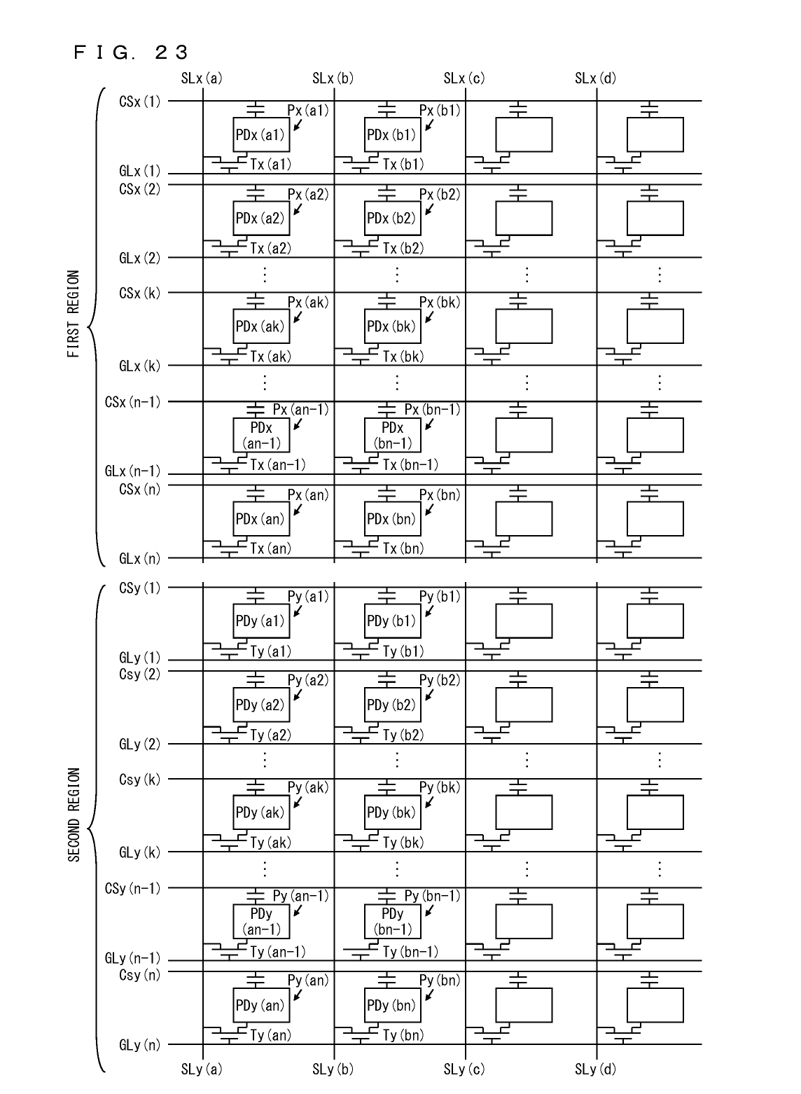

FIG. 23 is an equivalent circuit diagram illustrating part of the liquid crystal panel 2a. As illustrated in FIG. 23, the liquid crystal panel 2a is configured so that, in the first region, (I) data signal lines SLx(a), SLx(b), SLx(c), and SLx(d) are arranged in this order, (II) scan signal lines GLx(1), GLx(2), . . . , GLx(k), . . . , GLx(n−1), and GLx(n), each of which extends in a horizontal direction (right-left direction in FIG. 23), are arranged in this order, and (III) retention capacitor wires CSx(1), CSx(2), . . . , CSx(k), . . . , CSx(n−1), and CSx(n) are arranged in this order to correspond to the respective scan signal lines GLx. Note that k is an integer that is equal to or more than 1 and is equal to or less than n (1≦k<n). Note also that n is, for example, 540 (540th line).

In the first region, (I) a pixel Px(a1) is provided so as to correspond to an intersection of the data signal line SLx(a) and the scan signal line GLx(1), (II) a pixel Px(a2) is provided so as to correspond to an intersection of the data signal line SLx(a) and the scan signal line GLx(2), and (III) a pixel Px(ak) is provided so as to correspond to an intersection of the data signal line SLx(a) and the scan signal line GLx(k). Likewise, a pixel Px(bk) is provided so as to correspond to an intersection of the data signal line SLx(b) and the scan signal line GLx(k).

A pixel electrode PDx is provided on each pixel Px. A pixel electrode PDx(a1) on the pixel Px(a1) is connected to the data signal line SLx(a) via a transistor Tx(a1) which is connected to the scan signal line GLx(1). A pixel electrode PDx(a2) on the pixel Px(a2) is connected to the data signal line SLx(a) via a transistor Tx(a2) which is connected to the scan signal line GLx(2). A pixel electrode PDx(ak) on the pixel Px(ak) is connected to the data signal line SLx(a) via a transistor Tx(ak) which is connected to the scan signal line GLx(k). Likewise, a pixel electrode PDx(bk) on the pixel Px(bk) is connected to the data signal line SLx(b) via a transistor Tx(bk) which is connected to the scan signal line GLx(k).

On the other hand, as illustrated in FIG. 23, the second region is configured so that (I) data signal lines SLy(a), SLy(b), SLy(c), and SLy(d) are arranged in this order, (II) scan signal lines GLy(1), GLy(2), . . . , GLy(k), . . . , GLy(n−1), and GLy(n), each of which extends in a horizontal direction (right-left direction in FIG. 23), are arranged in this order, and (III) retention capacitor wires CSy(1), CSy(2), . . . , CSy(k), . . . , CSy(n−1), and CSy(n) are arranged in this order to correspond to the respective scan signal lines GLy. Note that k is an integer that is equal to or more than 1 and is equal to or less than n (1≦k≦n). Note also that n is, for example, 540 (540th line).

In the second region, (I) a pixel Py(a1) is provided so as to correspond to an intersection of the data signal line SLy(a) and the scan signal line GLy(1), (II) a pixel Py(a2) is provided so as to correspond to an intersection of the data signal line SLy(a) and the scan signal line GLy(2), (III) a pixel Py(ak) is provided so as to correspond to an intersection of the data signal line SLy(a) and the scan signal line GLy(k), a pixel Py(an−1) is provided so as to correspond to an intersection of the data signal line SLy(a) and the scan signal line GLy(n−1), and (IV) a pixel Py(an) is provided so as to correspond to an intersection of the data signal line SLy(a) and the scan signal line GLy(n). Likewise, a pixel Py(bk) is provided so as to correspond to an intersection of the data signal line SLy(b) and the scan signal line GLy(k).

As in the first region, a pixel electrode PDy, which is provided on each pixel Py, is connected to a data signal line SLy via a transistor Ty that is connected to a scan signal line GLy.

Note that (i) the scan signal lines GLx and GLy are sequentially selected, one after another, in the first and second regions, respectively, (ii) respective scanning directions of the scan signal lines GLx and GLy match each other, and (iii) the first and second regions are arranged in this order with respect to the scanning directions. In FIG. 23, the liquid crystal panel 2a is scanned in order from an upper part (upstream) of the sheet to a lower part (downstream) of the sheet.

(Screen Division Drive System)

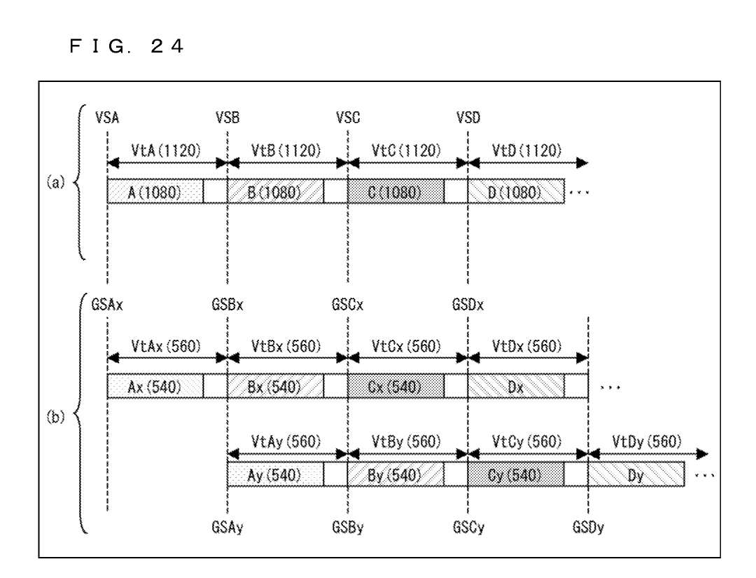

An example of a writing operation of the liquid crystal display device 1a will be described below. (a) of FIG. 24 illustrates respective input timings in frames A through D. According to the configuration of FIG. 24, (i) vertical sync signals VSA through VSD are inputted during the frames A through D, respectively and (ii) periods VtA through VtD, which are periods of the frames A through D respectively, are each made up of 1120 lines (40 lines of which make up a blanking period). (b) of FIG. 24 illustrates timings of the writing operation according to the liquid crystal display device 1a.

As illustrated in (b) of FIG. 24, a data signal, which corresponds to a first half Ax of the frame A (first frame), is written into the first region, and then another data signal, which corresponds to a second half Ay of the frame A, is written into the second region. In so doing, (i) another data signal, which corresponds to a first half Bx of the frame B (second frame), is written into the first region, so that a writing period for the second half Ay and a writing period for the first half Bx overlap each other and then (ii) another data signal, which corresponds to a second half By of the frame B, is rewritten into the second region. Then, (I) another data signal, which corresponds to a first half Cx of the frame C (third frame), is written into the first region, so that a writing period for the second half By and a writing period for the first half Cx overlap each other and then (II) another data signal, which corresponds to a second half Cy of the frame (C), is rewritten into the second region.

In (b) of FIG. 24, (i) a gate start pulse in the first frame Ax is represented as GSAx, (ii) a gate start pulse in the first frame Bx is represented as GSBx, (iii) a gate start pulse in the first frame Cx is represented as GSCx, (iv) a gate start pulse in the first frame Dx is represented as GSDx, (v) a gate start pulse in the second frame Ay is represented as GSAy, (vi) a gate start pulse in the second frame By is represented as GSBy, (vii) a gate start pulse in the second frame Cy is represented as GSCy, and (viii) a gate start pulse in the second frame Dy is represented as GSDy. In addition, (I) the respective timings of the vertical sync signal VSA and the gate start pulse GSAx are synchronized with each other, (II) the respective timings of the vertical sync signal VSB, the gate start pulse GSBx, and the gate start pulse GSAy are synchronized with one another, (III) the respective timings of the vertical sync signal VSC, the gate start pulse GSCx, and the gate start pulse GSBy are synchronized with one another, and (IV) the respective timings of the vertical sync signal VSD, the gate start pulse GSDx, and the gate start pulse GSCy are synchronized with one another. Furthermore, periods VtAx through VtDx, which are periods of the first frames Ax through Dx respectively, are each made up of 560 lines (20 lines of which make up a blanking period).

According to the liquid crystal display device 1a which employs a screen division (top-bottom division) drive system, it is only necessary, for example, to output (scan) 540 lines during the period in which 1080 lines are inputted (see (a) and (b) of FIG. 24). This allows 1H (1 horizontal scanning period) on an output end to be twice as long as 1H (1 horizontal scanning period) on an input end, and therefore allows an increase in charging rate of each pixel. In addition, it is possible to simultaneously achieve (i) a high-resolution liquid crystal display device and (ii) a reduction in length of time required for writing a data signal into each pixel.

Note that a part at which the liquid crystal panel is divided (i.e. a boundary between the first and second regions) is not limited to a center of the upper and lower parts of the liquid crystal panel. In fact, the first and second regions can have differing surface areas. In such a case, a data signal, which corresponds to part of a frame, is written into the first region whereas another data signal, which corresponds to the rest of the frame, is written into the second region.

(V-Inversion Drive System)

The liquid crystal display device 1a is driven by use of a V-inversion drive system. For example, according to the liquid crystal display device 1a, (i) polarities of respective data signals, which are supplied to two adjacent data signal lines during a single horizontal scanning period, are opposites and (ii) a 1V inversion drive system is employed in which polarities of data signals, which are supplied to the data signal lines, are inverted at each vertical scanning period (1V). Alternatively, the V-inversion drive system used for driving the liquid crystal display device 1a can be configured so that polarities of respective data signals, which are supplied to two adjacent data signal lines during a single horizontal scanning period, are the same.

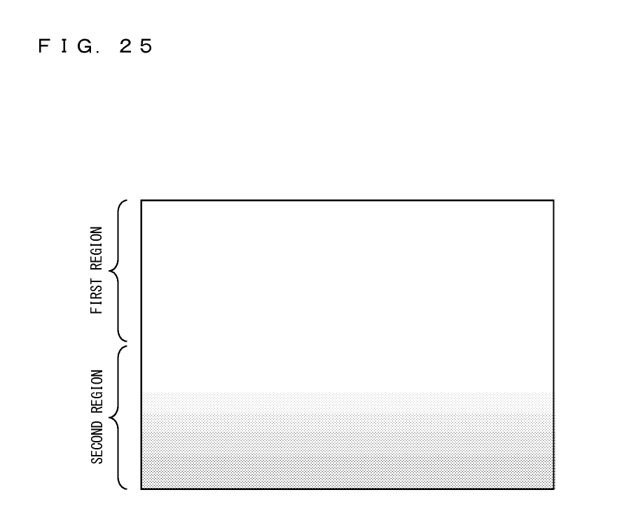

Note that it is a common problem of a liquid crystal display device of a V-inversion drive type that, due to parasitic capacitance (Csd) generated between data signal lines and corresponding pixel electrodes, a pixel potential toward the last scan signal line to be scanned falls lower than a potential of a data signal, and therefore luminance of a part of a display screen toward the last scan signal line decreases. For example, in a case where a solid white image is to be displayed, a part of a display screen toward the last scan signal to be scanned becomes dark, as illustrated in FIG. 25.

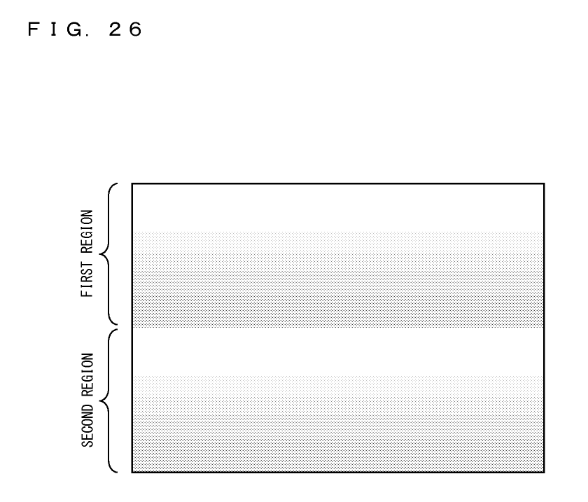

Therefore, in a case where the V-inversion drive system is applied to the screen division drive system, a part of the display screen toward the last scan signal line to be scanned in the first region, which part decreases in luminance, and a part of the display screen toward the first scan signal line to be scanned in the second region, which part retains an intended luminance, are located immediately adjacent to each other. This, in a case where a solid white image is to be displayed, causes a luminance variation (luminance boundary) between the first and second region be significant, and therefore causes a decrease in display quality (see FIG. 26).

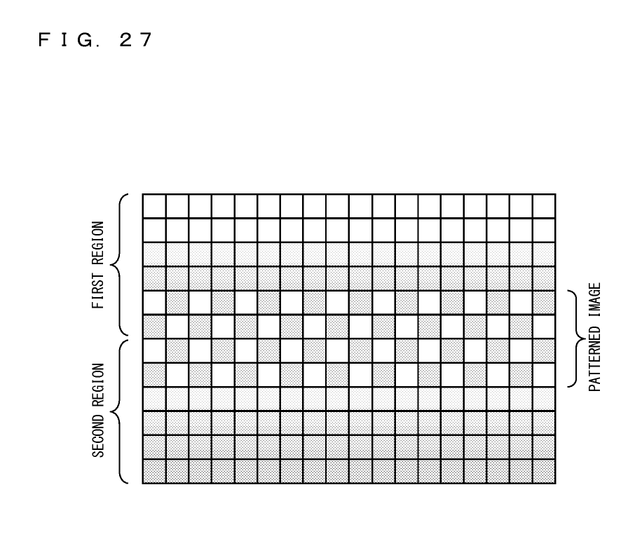

By carrying out the grayscale correction described in the above Examples of the present embodiment, it is possible to cause a luminance boundary between the first and second regions of such a liquid crystal display device to be unnoticeable. This prevents a reduction in display quality. For example, as is the case of FIG. 27 that illustrates a display screen which has been subjected to the grayscale correction of Example 2, a luminance boundary can be made unnoticeable by displaying a check-patterned image at (i) a part (lower part) toward the last scan signal line to be scanned in a first region and (ii) a part (upper part) toward the first scan signal line to be scanned in the second region.

Note that the first display control circuit 5x and the second display control circuit 5y of the liquid crystal display device 1a can each have a configuration identical to that of the display control circuit 5 illustrated in FIG. 1. Therefore, a part of a corrected image, which part corresponds to the first region, can be generated by the first display control circuit 5x whereas the other part of the corrected image, which part corresponds to the second region, can be generated by the second display control circuit 5y.

The above configuration examples each illustrated a luminance boundary in the liquid crystal display device that employs the top-bottom division drive system. Note, however, that a liquid crystal display device, in which a plurality of adjacent source drivers are provided, can be employed as another configuration example. According to such a liquid crystal display device, a luminance boundary (boundaries) can be recognizable at a part(s) at which a plurality of display regions are joined together, the plurality of display regions being driven by the respective plurality of source drivers. Even in a case of such a liquid crystal display device, the luminance boundary (boundaries) between the display regions can be made unnoticeable by carrying out the grayscale correction described in the above Examples.

Furthermore, in some cases, display unevenness (luminance boundary) may be recognizable in the form of a horizontal or vertical line(s), due to a light source of a backlight which is provided on a back surface of the liquid crystal panel 2. However, even such display unevenness can be made unnoticeable by carrying out the grayscale correction described in the above Examples.

According to the display device in accordance with the present embodiment, the patterned image can be displayed on the entire part of at least part of the display screen.

Alternatively, according to the display device in accordance with the present embodiment, the patterned image can be displayed only on a predetermined region of the part of the display screen.

According to the configuration, a part of the display screen, which part includes a luminance boundary, is subjected to grayscale correction. This makes it possible to minimize a reduction in the grayscale rendering performance (described later in detail).

The display device in accordance with the present embodiment can be configured such that (i) the patterned image is displayed within the predetermined region of the part and (ii) a grayscale-corrected image, which is obtained by correcting an input grayscale of an input image, is displayed outside the predetermined region so that a display luminance is uniform across outside the predetermined region.

According to the configuration, a patterned image is displayed on a part of the display screen, which part includes a luminance boundary. This allows the luminance boundary to be unnoticeable as well as causes the remaining part of the display screen, where display unevenness is present, to be subjected to grayscale correction. Therefore, it is possible to cause an overall luminance across the entire display screen to be uniform.

The display device can be configured such that the patterned image is a check-patterned image.

The display device can be configured such that the patterned image is configured by arranging, in a mixed manner, pixels A each having A′ grayscale and pixels B each having B′ grayscale which is different from A′ grayscale, so that, in the part of the display screen, a longer distance from the predetermined region is relative to a lower mixture rate of the pixels A and B.

With the configuration, it is possible to cause the luminance boundary to be unnoticeable as well as cause an overall luminance across the entire display screen to be uniform.

The display device can be configured such that, in a case where an image to be displayed on the display screen has a first luminance and a second luminance respectively corresponding to a first grayscale and a second grayscale with respect to an input grayscale of the input image, the patterned image is made up of first pixels each having the first grayscale and of second pixels each having the second grayscale.

The display device can be configured such that, in a case where an image to be displayed on the display screen has a first luminance and a second luminance respectively corresponding to a first grayscale and a second grayscale with respect to an input grayscale of the input image, the patterned image includes pixels each having a grayscale higher than the first and second grayscales.

With the configuration, it is possible to cause a luminance boundary to be unnoticeable as well as allow for an increase in display quality of, in particular, a region where a grayscale is low.

The display device can be configured such that the patterned image is displayed on at least the predetermined region of the part of the display screen in a case where (i) an image having a uniform grayscale is to be displayed at least on the part of the display screen and (ii) the input image has a low grayscale.

The display device can be configured to further include: a plurality of color filters which are adjacently arranged, the predetermined region including a part at which the plurality of color filters are joined together.

With the configuration, it is possible to cause a luminance boundary to be unnoticeable, which luminance boundary is recognizable on a part of the display region at which color filter are joined together.

The display device can be configured such that: a first region and a second region of a display panel are each provided with data signal lines, scan signal lines, and pixels, so that a data signal corresponding to a first part of a frame is written into the first region whereas a data signal corresponding to a second part of the frame is written into the second region, by which second part the first part is followed; respective scanning directions in the first and second regions match each other, and the first and second regions are arranged in this order with respect to the scanning directions; and the predetermined region includes a boundary between the first and second regions.

With the configuration, it is possible to cause a luminance boundary to be unnoticeable, which luminance boundary is recognizable on a part of the display region at which the first and second regions are joined together.

The liquid crystal display device can be configured such that, in a case where an input grayscale of the input image is equal to or lower than a predetermined grayscale, it being determined in the step (ii) that the input image needs to be corrected whereas, in a case where the input grayscale of the input image is higher than the predetermined grayscale, it being determined in the step (ii) that the input image does not need to be corrected.

The display device can be configured such that an image based on the input image is displayed in a case where it is determined in the step (ii) that the input image does not need to be corrected.

A display device in accordance with the present embodiment includes: a display screen on which an input image is displayed, the input image being based on input image data which has been inputted into the display device, in a case where an image having a uniform grayscale is to be displayed on at least part of the display screen, (i) the display screen displaying, on at least a predetermined region of the part, a patterned image which has been set in accordance with the input image in advance and (ii) the display screen displaying, on a remaining part other than the predetermined region, a grayscale-corrected image obtained by correcting an input grayscale of the input image, so that a display luminance is uniform across the remaining part.

A display device in accordance with the present embodiment includes: a display screen on which an input image is displayed, the input image being based on input image data which has been inputted into the display device, in a case where an image having a uniform grayscale is to be displayed on at least part of the display screen, (i) the display screen displaying, on at least a predetermined region of the part, a patterned image which has been set in accordance with the input image in advance and (ii) the patterned image being configured by arranging, in a mixed manner, pixels A each having A′ grayscale and pixels B each having B′ grayscale which is different from A′ grayscale, so that, in the part of the display screen, a longer distance from the predetermined region is relative to a lower mixture rate of the pixels A and B.

A method of the present embodiment is a method of driving a display device, said display device including: a display screen on which an input image is displayed, the input image being based on input image data which has been inputted into the display device, said method comprising the steps of: (i) receiving an input image from an external source; (ii) determining, by recognizing the input image, whether or not the input image needs to be corrected; (iii) in a case where it was determined in the step (ii) that the input image needs to be corrected, obtaining a patterned image which corresponds to the input image thus recognized in the step (ii) and which is stored in a storage section in advance; and (iv) generating a corrected image in accordance with the patterned image thus obtained in the step (iii) and with the input image thus received in the step (i), in a case where it was determined in the step (ii) that the input image needs to be corrected, an image based on the corrected image being displayed, and in a case where an image having a uniform grayscale is to be displayed on at least part of the display screen, the corrected image being made up of (I) a patterned image which is set in accordance with the input image in advance and which is displayed on at least a predetermined region of the part and (II) a grayscale-corrected image, obtained by correcting an input grayscale of the input image, which is displayed on a remaining part other than the predetermined region, so that a display luminance is uniform across the remaining part.

A method of the present embodiment is a method of driving a display device, said display device including: a display screen on which an input image is displayed, the input image being based on input image data which has been inputted into the display device, said method comprising the steps of: (i) receiving an input image from an external source; (ii) determining, by recognizing the input image, whether or not the input image needs to be corrected; (iii), in a case where it was determined that the input image needs to be corrected in the step (ii), obtaining a patterned image which corresponds to the input image thus recognized in the step (ii) and which is stored in a storage section in advance; and (iv) generating a corrected image in accordance with the patterned image thus obtained in the step (iii) and with the input image thus received in the step (i), in a case where it is determined in the step (ii) that the input image needs to be corrected, an image based on the corrected image being displayed, and in a case where an input grayscale of the input image is equal to or lower than a predetermined grayscale, it being determined in the step (ii) that the input image needs to be corrected whereas, in a case where the input grayscale of the input image is higher than the predetermined grayscale, it being determined in the step (ii) that the input image does not need to be corrected.

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

### INDUSTRIAL APPLICABILITY

The present invention is applicable to, for example, liquid crystal televisions.

### REFERENCE SIGNS LIST

1, 1a Liquid crystal display device (display device)
   2, 2a Liquid crystal panel (display section)
   3 Source driver
   4 Gate driver
   5 Display control circuit
   5x First display control circuit
   5y Second display control circuit
   51 Image input section
   52 Image determining section
   53 Correction image storage section (storage section)
   54 Image converting section
   55 Timing control section
   56 Corrected image generating section
   57 Image output section

1. A display device comprising:
a display screen on which an input image is displayed, the input image being based on input image data which has been inputted into the display device,
in a case where an image having a uniform grayscale is to be displayed on at least part of the display screen, (i) the display screen displaying, on at least a predetermined region of the part, a patterned image which has been set in accordance with the input image in advance and (ii) the display screen displaying, on a remaining part other than the predetermined region, a grayscale-corrected image obtained by correcting an input grayscale of the input image, so that a display luminance is uniform across the remaining part.

2. A display device comprising:
a display screen on which an input image is displayed, the input image being based on input image data which has been inputted into the display device,
in a case where an image having a uniform grayscale is to be displayed on at least part of the display screen, (i) the display screen displaying, on at least a predetermined region of the part, a patterned image which has been set in accordance with the input image in advance and (ii) the patterned image being configured by arranging, in a mixed manner, pixels A each having A′ grayscale and pixels B each having B′ grayscale which is different from A′ grayscale, so that, in the part of the display screen, a longer distance from the predetermined region is relative to a lower mixture rate of the pixels A and B.

3. The display device as set forth in claim 1, wherein the patterned image is a check-patterned image.

4. The display device as set forth in claim 1, wherein, in a case where an image to be displayed on the display screen has a first luminance and a second luminance respectively corresponding to a first grayscale and a second grayscale with respect to an input grayscale of the input image, the patterned image is made up of first pixels each having the first grayscale and of second pixels each having the second grayscale.

5. The display device as set forth in claim 1, wherein, in a case where an image to be displayed on the display screen has a first luminance and a second luminance respectively corresponding to a first grayscale and a second grayscale with respect to an input grayscale of the input image, the patterned image includes pixels each having a grayscale higher than the first and second grayscales.

6. The display device as set forth in claim 1, wherein the patterned image is displayed on at least the predetermined region of the part of the display screen in a case where (i) an image having a uniform grayscale is to be displayed at least on the part of the display screen and (ii) the input image has a low grayscale.

7. A display device as set forth in claim 1, further comprising:
a plurality of color filters which are adjacently arranged,
the predetermined region including a part at which the plurality of color filters are joined together.

8. The display device as set forth in claim 1, wherein:
a first region and a second region of a display panel are each provided with data signal lines, scan signal lines, and pixels, so that a data signal corresponding to a first part of a frame is written into the first region whereas a data signal corresponding to a second part of the frame is written into the second region, by which second part the first part is followed;
respective scanning directions in the first and second regions match each other, and the first and second regions are arranged in this order with respect to the scanning directions; and
the predetermined region includes a boundary between the first and second regions.

9. (canceled)

10. A method of driving a display device,
said display device comprising:
a display screen on which an input image is displayed, the input image being based on input image data which has been inputted into the display device,
said method comprising the steps of:
(i) receiving an input image from an external source;
(ii) determining, by recognizing the input image, whether or not the input image needs to be corrected;
(iii), in a case where it was determined that the input image needs to be corrected in the step (ii), obtaining a patterned image which corresponds to the input image thus recognized in the step (ii) and which is stored in a storage section in advance; and
(iv) generating a corrected image in accordance with the patterned image thus obtained in the step (iii) and with the input image thus received in the step (i),
in a case where it is determined in the step (ii) that the input image needs to be corrected, an image based on the corrected image being displayed, and
in a case where an input grayscale of the input image is equal to or lower than a predetermined grayscale, it being determined in the step (ii) that the input image needs to be corrected whereas, in a case where the input grayscale of the input image is higher than the predetermined grayscale, it being determined in the step (ii) that the input image does not need to be corrected.

11. The method as set forth in claim 9, wherein an image based on the input image is displayed in a case where it is determined in the step (ii) that the input image does not need to be corrected.
